(19) United States
(12) Patent Application Publication
(10) Pub. No.: US 2005/0246114 A1
(43) Pub. Date: Nov. 3, 2005

(54) In-line field sensor

(76) Inventors: Randy K. Rannow, Albany, OR (US); Samuel Naffziger, Fort Collins, CO (US); Karl Bois, Fort Collins, CO (US); Bradley D. Winick, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/835,506

(22) Filed: Apr. 29, 2004

(51) Int. Cl. G06F 19/00

(52) U.S. Cl. 702/65

(57) ABSTRACT

Methodology, systems, and media associated with sensing a magnetic field produced by an electrical signal flowing through a conductor are described. One exemplary system may include a connector that conveys the electrical signal between conductors and an in-line field sensor positioned and configured to sense the magnetic field produced by the electrical signal without affecting the electrical signal.

### BACKGROUND

When electric current flows through a conductor, a magnetic field is produced in the space around the conductor. Varying the electric current may cause the magnetic field to vary, which can produce an electric field. Thus, an electromagnetic field may be produced around a conductor by a varying current in the conductor. The electromagnetic field is the combination of the magnetic field caused by the current and the electric field caused by the changing magnetic field.

Conventionally, to measure current flowing through a conductor, devices like resistive shunts, current transformers, Hall-effect based sensors, and so on were employed. But shunts insert a voltage drop into a circuit being analyzed and are not isolated from the circuit being analyzed, current transformers work only for alternating current (AC) and circuits including Hall-effect based sensors may have limited usefulness based on their size, which may depend on a magnetic core element.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example connector configured with an in-line field sensor.

FIG. 2 illustrates another example connector configured with two in-line field sensors.

FIG. 3 illustrates an example power regulating system.

FIG. 4 illustrates an example method for monitoring current in a conductor in a connector.

FIG. 5 illustrates an example method for configuring a connector with an in-line field sensor.

FIG. 6 illustrates an example computing environment in which example connectors configured with in-line field sensors may be located.

FIG. 7 illustrates an example image forming device in which example connectors configured with in-line field sensors may be located.

### DETAILED DESCRIPTION

This application describes example systems, methods, and computer-readable mediums associated with an in-line field sensor detecting, measuring, analyzing, and/or responding to attributes of an electrical signal flowing through a conductor in a connector without changing the electrical signal. The attributes may include, for example, the current, voltage, and/or power associated with the electrical signal. In one example, the in-line field sensor may be a magneto-resistive field sensing device. A magneto-resistive field sensing device can measure a magnetic field produced by a current flowing in a conductor when the sensing device is positioned within the field. Magneto-resistive sensing devices may include anisotropic magneto-resistive (AMR) devices, giant magneto-resistive (GMR) devices, tunneling magneto-resistive (TMR) devices, and the like.

A magneto-resistive sensing device may include conductive materials whose resistance (R) changes in the presence of a magnetic field. Thus, a magneto-resistive sensing device can provide a value for R to facilitate analyzing the value of other attributes in equations like V=IR (V=voltage, I=current) and P=I²R, (P=power), which in turn facilitates analyzing attributes like current, current changes, power, power changes, and so on. Analyzing these attributes can facilitate, for example, configuring a feedback logic to generate a signal for controlling electric and/or electronic components that provide the electrical signal flowing through the conductor.

Many conducting materials exhibit some magnetoresistance. Permalloys like nickel-iron alloys and other ferromagnetic materials exhibit detectably alterable magneto-resistances that facilitate detecting and/or analyzing a magnetic field and thus analyzing a current that produced the magnetic field without changing the current. Thus, field sensors based on the magneto-resistive effect may include a permalloy sensing layer responsive to magnetic fields. The sensor layer may spontaneously magnetize itself parallel to its long axis. A fixed magnetic field may also be applied in the long axis direction to establish a single magnetic domain in the sensor layer. When there is no external (e.g., transverse) magnetic field impinging on the sensor layer, it may be harder for conduction electrons to flow the length of the sensor layer. This results in a relatively higher resistance for the sensor material. But when an external (e.g., transverse) magnetic field is present and impinges on the sensor layer, the magnetic orientation of the sensor layer can be rotated. This can make it easier for the conduction electrons to flow, which results in a relatively lower resistance for the sensor material. Thus, a detectably changeable resistance in field sensing devices based on the magneto-resistive effect can vary with respect to the presence and/or strength of a magnetic field that can be produced by current flowing, for example, through a conductor in a connector.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, an application specific integrated circuit (ASIC), a compact disc (CD), a digital video disk (DVD), a random access memory (RAM), a read only memory (ROM), a programmable read only memory (PROM), an electronically erasable programmable read only memory (EEPROM), a disk, a carrier wave, a memory stick, a floppy disk, a flexible disk, a hard disk, a magnetic tape, other magnetic media, a CD-ROM, other optical media, punch cards, paper tape, other physical media with patterns of holes, an EPROM, a FLASH-EPROM, or other memory chip or card, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an ASIC, a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal”, as used herein without a qualifier, includes, but is not limited to, one or more electrical or optical signals, analog or digital, one or more computer or processor instructions, messages, a bit or bit stream, or other means that can be received, transmitted and/or detected.

An “operable connection”, or a connection by which entities are “operably connected”, is one in which signals, physical communication flow, and/or logical communication flow may be sent and/or received directly and/or indirectly between entities like logics, processes, and so on. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantifies and are merely convenient labels applied to these quantities. Unless specifically stated otherwise, it is appreciated that throughout the description, terms like processing, computing, calculating, determining, displaying, characterizing, or the like, refer to actions and processes of a computer system, logic, processor, or similar electronic device that manipulates and transforms data represented as physical (electronic) quantities.

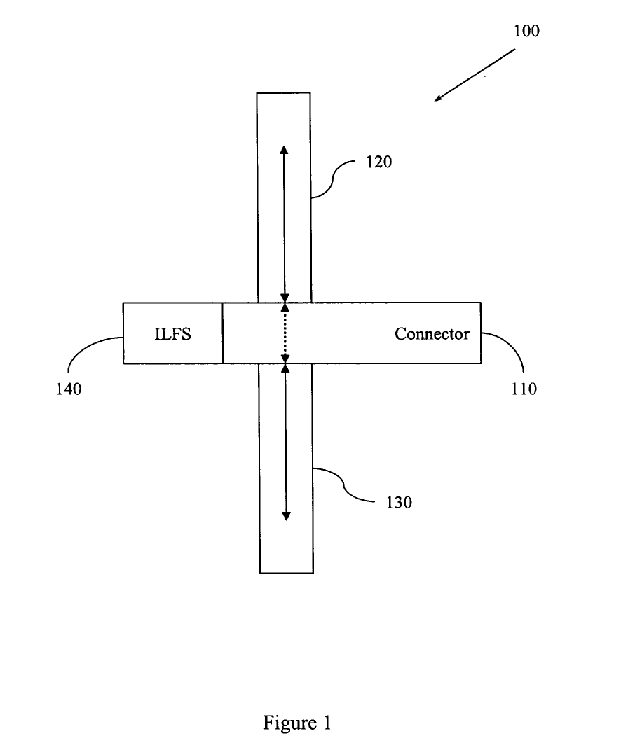

FIG. 1 illustrates a system 100 that includes a connector 110 that is configured to convey an electrical signal between a first conductor 120 and a second conductor 130. The first conductor 120 may be, for example, a wire leading into the connector 110 and the second conductor 130 may be, for example, a wire leading out of the connector 110. The first conductor 120 and second conductor 130 may be connected, for example, to pins in the connector 110. In one example, the connector 110 may be a type employed in computer hardware applications like supplying power to a motherboard, supplying data signals and/or power to a USB port, and the like. As the electrical signal flows through the first conductor 120, the connector 110, and the second conductor 130, it may create a magnetic field that can be described according to Maxwell's Laws. Thus, the connector 110 may be configured with an in-line field sensor 140 (ILFS) that is positioned to be within the magnetic field created by the electrical signal as it flows through the connector 110. Conventionally, analyzing the electrical signal may have required an intrusive technique like those described in the background section. Here, however, the in-line field sensor 140 may be configured to detect the magnetic field without affecting the electrical signal carried by the conductors 120, 130.

In one example, the in-line field sensor 140 may be a two terminal device. The in-line field sensor 140 may be configured to detect a magnetic field produced by an electrical signal passing through the connector 110, where the electrical signal voltage is in the range of about −50 mV to about 50 mV. In another example, the in-line field sensor 140 may be configured to detect a magnetic field produced by an electrical signal whose voltage is in the range of about −15 V to about 15 V. While two ranges, −50 mV to 50 mV and −15 V to 15V are described, it is to be appreciated that example connectors can be configured with in-line field sensors configured to detect, measure, and/or analyze magnetic fields produced by electrical signals with various voltages.

In one example, the in-line field sensor 140 may be configured to detect a magnetic field produced by an electrical signal passing through the connector 110, where the electrical signal has a current in the range of about 0 A to about 50 mA while in another example the in-line field sensor 140 may be configured to detect fields produced by a current in the range of about 0 A to about 1A. Again, while two amperage ranges are described, it is to be appreciated that an in-line field sensor 140 can be configured to process magnetic fields produced by electrical signals with various amperages like −1A to +1A and so on.

The in-line field sensor 140 may be, for example, a magneto-resistive effect device. Thus, in one example, the in-line field sensor 140 may be an anisotropic magnetic-resistive (AMR) device. In other examples, the in-line field sensor 140 may be, for example, a giant magneto-resistive (GMR) device or a tunneling magneto-resistive (TMR) device. While AMR, GMR, and TMR devices are described, it is to be appreciated that the in-line field sensor 140 may be based on other magneto-resistive techniques. Since the in-line field sensor 140 may be a magneto-resistive effect device, in one example the in-line field sensor 140 may include a permalloy sensor layer.

In FIG. 1, the in-line field sensor 140 is illustrated being attached to the connector 110. However, in other examples the in-line field sensor 140 may be embedded in the connector 110, manufactured into the connector 110, retro-fitted onto the connector 110, glued onto the connector 110, and so on. In another example, the in-line field sensor 140 may be positioned to be within the magnetic field to be detected/measured/analyzed but not in physical contact with the connector 110. For example, the in-line field sensor 140 may be placed in close proximity (e.g., 0.01 inch) to the connector 110 but not actually touch the connector 110 since the magnetic field produced by the electrical signal flowing through the connector 110 may extend outwards beyond the boundaries of the connector 110.

The in-line field sensor 140 may sense, monitor, detect, analyze and so on the magnetic field using various techniques. In one example, the in-line field sensor 140 may monitor the magnetic field using frequency synthesis, coding synthesis, and/or other similar techniques.

The first conductor 120 and the second conductor 130 may carry an electrical signal from a source to a destination. For example, the electrical signal may be provided to destinations including, but not limited to, a microprocessor, a dual in-line memory module (DIMM), an ASIC, an integrated circuit, a bus, and so on.

The in-line field sensor 140 may be positioned in various locations and orientations with respect to the connector 110 and/or the magnetic field produced by the electrical signal flowing through the connector 110. In one example, the in-line field sensor 140 is positioned so that the easy axis of the in-line field sensor 140 is orthogonal to the magnetic field.

Connectors like connector 110 that are configured with an in-line field sensor like in-line field sensor 140 may be embedded in, utilized in, attached to, located in, and so on in devices like computers, image forming devices, printers, cellular telephones, personal digital assistants, embedded systems, and so on.

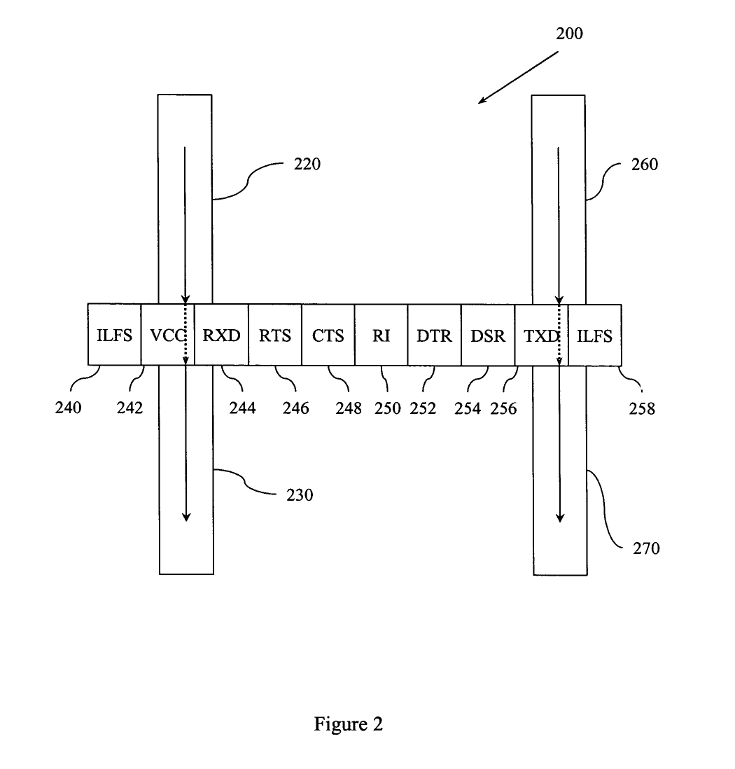

FIG. 2 illustrates an example connector 200 configured with two in-line field sensors. While two in-line field sensors are illustrated, it is to be appreciated that connectors can be configured with a greater and/or lesser number of in-line field sensors.

Connector 200 includes a first in-line field sensor 240 that is positioned to detect, measure, and/or analyze a magnetic field produced by an electrical signal associated with a VCC portion 242 of communication port connector 200. The voltage supplied through the VCC portion 242 of the connector 200 may be carried from a first conductor 220 to a second conductor 230 via the connector 200. A control circuit associated with the telecommunication component being supplied the VCC voltage may be configured to monitor and/or react to the condition of the voltage being supplied. Thus, the in-line field sensor 240 may be positioned and configured to facilitate analyzing the VCC signal.

The communication port connector 200 may transmit several electrical signals associated with telecommunications. For example, the connector 200 may include a conductor for a received data signal 244, various communication status signals (e.g., RTS 246, CTS 248, RI 250, DTR 252, DSR 254). Additionally, the communication port connector 200 may pass a transmitted data (TXD) 256 signal through the connector 200. A data communications monitor may be configured to determine when data is being transmitted. Thus, an in-line field sensor 258 may be positioned and configured to monitor a magnetic field produced when a transmitted data signal is passed from conductor 260 through connector 200 by the TXD portion 256 to conductor 270. While a connector 200 associated with data communications is illustrated, it is to be appreciated that connectors associated with other applications like bus control, power supply control, memory management, and so on can be configured with in-line field sensors.

Thus, in one example, means for analyzing an attribute(s) of an electrical signal flowing through a conductor in connector 200 without affecting the electrical signal can include, but are not limited to, a magneto-resistive field sensing device, a logic for analyzing a signal(s) produced by the magneto-resistive field sensing device, and so on. Similarly, means for selectively controlling the electrical signal based on the attribute(s) can include, but are not limited to, a feedback logic.

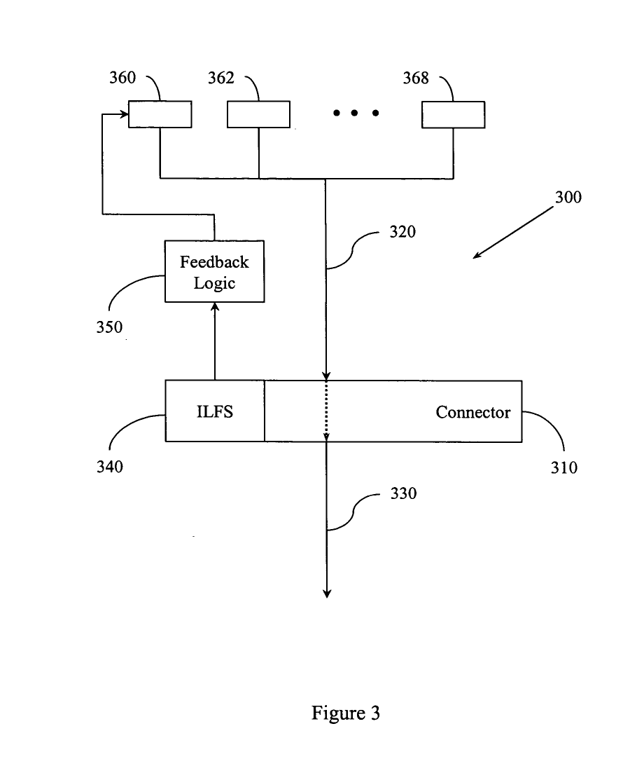

FIG. 3 illustrates an example power regulating system 300 that includes a connector 310 configured to convey an electric signal from a first conductor 320 to a second conductor 330. The connector 310 is configured with an in-line field sensor 340 like those described in connection with FIG. 1. Additionally, the system 300 includes a feedback logic 350 that is operably connected to the in-line field sensor 340. The feedback logic 350 may be configured to receive a signal from the in-line field sensor 340. The signal may, for example, be related to an attribute of the electrical signal flowing through the connector 310. By way of illustration, the signal may indicate an instant field strength for a magnetic field produced by the electrical signal, a change in field strength for the magnetic field, a computed amperage of the signal, a computed voltage for the signal, and so on.

The feedback logic 350, may, for example, be tasked with controlling devices (e.g., devices 360 through 368) that are involved in providing the electrical signal to the first conductor 320 and thus through the connector 310 to the second conductor 330 and a destination(s). Thus, the feedback logic 350 may provide a signal to the devices (e.g., devices 360 through 368) to increase, decrease, maintain, and so on various attributes associated with the electrical signal being provided to conductor 320. In this way, for example, a conditioned electrical signal that satisfies desired characteristics (e.g., amperage range, voltage range) may be maintained. Additionally, and/or alternatively, the feedback logic 350 may be configured to track (e.g., log) attributes associated with the electrical signal.

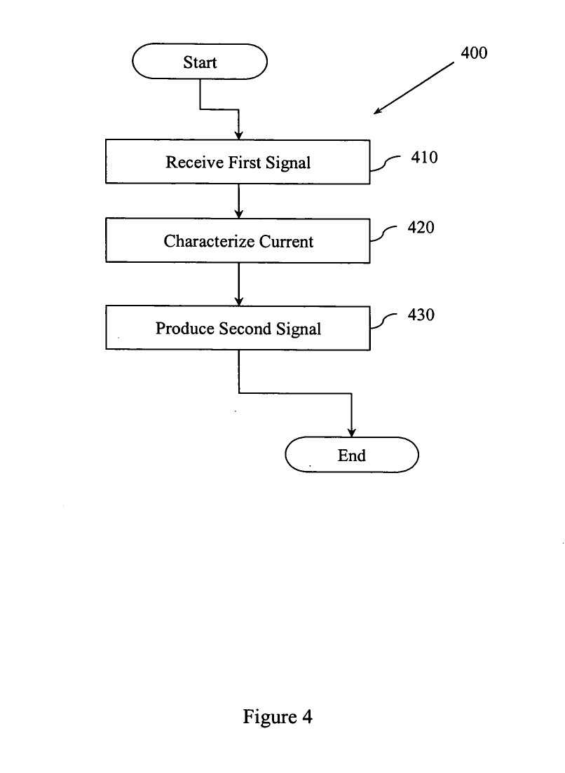

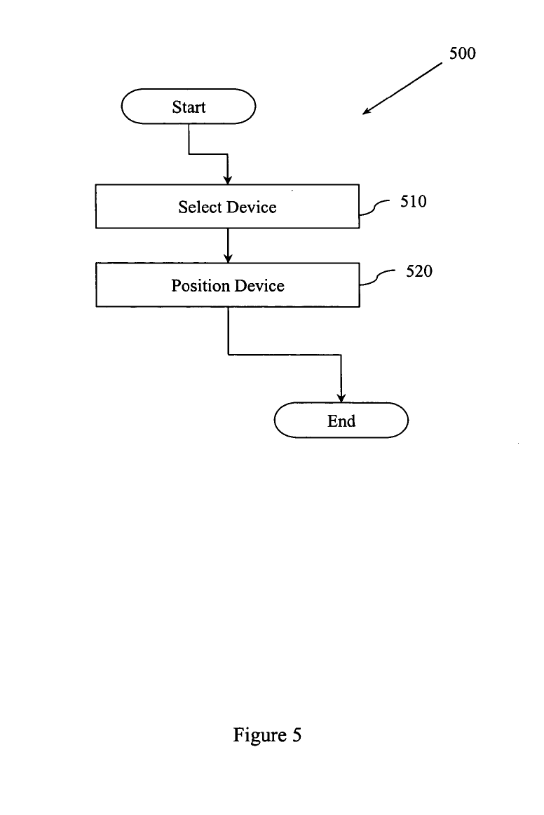

Example methods may be better appreciated with reference to the flow diagrams of FIG. 4 and FIG. 5. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as processor executable instructions and/or operations stored on a computer-readable medium.

In the flow diagrams, blocks denote “processing blocks” that may be implemented, for example, in software. Additionally and/or alternatively, the processing blocks may represent functions and/or actions performed by functionally equivalent circuits like a digital signal processor (DSP), an ASIC, and the like.

A flow diagram does not depict syntax for any particular programming language, methodology, or style (e.g., procedural, object-oriented). Rather, a flow diagram illustrates functional information one skilled in the art may employ to fabricate a logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 4 illustrates an example method 400 for detecting, analyzing, measuring, monitoring and so on an attribute(s) of an electrical signal flowing in a conductor in a connector. While current is described as an example attribute, it is to be appreciated that other attributes (e.g., power, voltage) of the electrical signal can be detected, monitored, measured, analyzed and so on by similar methods. The method 400 may include, for example, receiving a signal from a magneto-resistive sensing device that is positioned, at least partially, within a magnetic field produced by the electrical signal flowing through a connector. The signal received from the magneto-resistive sensing device may, for example, be related to a variable resistance in the magneto-resistive sensing device. This variable resistance may be determined, at least in part, by the magnetic field produced by the electric signal. Conventionally, analyzing the electrical signal may impact (e.g., change) the electrical signal. However, in method 400 the signal can be received without altering the electric signal. The received signal may indicate, for example, an instant resistance in the magneto-resistive device and/or a resistance change in the magneto-resistive device.

The method 400 may also include, at 420, characterizing an attribute(s) of the electrical signal based, at least in part, on the received signal. For example, if the received signal reports a measurement for the variable resistance in a magneto-resistive device then the electrical signal may be characterized based on that variable resistance measurement. Similarly, if the received signal reports a field strength for the magnetic field, then the electrical signal may be characterized based on that field strength.

The method 400 may also produce a second signal based, at least in part, on the characterization. For example, the second signal may be employed to condition (e.g., increase, decrease, maintain) the electrical signal, to report on the electrical signal, to initiate and/or terminate a process, to open a switch, and so on. Characterizing the electrical signal can include, for example, producing a current measurement, producing a current change measurement, producing a power measurement, producing a power change measurement, producing a voltage measurement, producing a voltage change measurement and so on.

While FIG. 4 illustrates various actions occurring in serial, it is to be appreciated that various actions illustrated in FIG. 4 could occur substantially in parallel. By way of illustration, a first process could substantially constantly receive a signal from a magneto-resistive device monitoring a magnetic field. Similarly, a second process could substantially constantly characterize the electrical signal producing the magnetic field and a third process could selectively produce second signals related to the characterization. While three processes are described, it is to be appreciated that a greater and/or lesser number of processes could be employed and that lightweight processes, regular processes, threads, and other approaches could be employed.

In one example, a computer-readable medium may store processor executable instructions operable to perform a method for characterizing an electrical signal flowing through a connector. The method may include, for example, receiving a signal from a magneto-resistive sensing device positioned at least partially within a magnetic field. The magnetic field may be produced, for example, by the electrical signal flowing through a connector. The signal may be related to a variable resistance in the magneto-resistive sensing device, where the variable resistance is determined, at least in part, by the magnetic field. The method includes receiving the signal without altering the electrical signal. Additionally, the method may include characterizing the electrical signal based on the received signal and selectively producing a second signal based on the characterization. While one method is described, it is to be appreciated that other computer-readable mediums could store other example methods described herein.

FIG. 5 illustrates an example method 500 for configuring a connector with an in-line field sensor to facilitate monitoring attributes of an electrical signal in a conductor associated with the connector. The method 500 may include, at 510, selecting a magneto-resistive sensing device with a resistance that can be detectably altered by an impinging magnetic field. The impinging magnetic field may have anticipated and/or desired attributes like field strength, field size, field orientation and so on. Thus, the method 500 may also include, at 520, positioning the magneto-resistive sensing device relative to a conductor so that the magneto-resistive sensing device will be impinged by the magnetic field when a current flows through the conductor. In one example, the conductor is associated with (e.g., contained by, runs through) an electrical connector.

In one example, the method 500 may also include configuring the magneto-resistive sensing device to generate a signal. The signal may communicate, for example, information concerning the magneto-resistive sensing device resistance. This signal may be employed by additional logics to perform actions like recording information about the electrical signal, the magnetic field it produces, and so on. Therefore, in one example, the method 500 may also include operably connecting a feedback logic to the magneto-resistive sensing device. With the signal available from the magneto-resistive sensing device to the feedback logic, the method 500 may also include configuring the feedback logic to condition the current based, at least in part, on the signal.

While FIG. 5 illustrates various actions occurring in serial, it is to be appreciated that various actions illustrated in FIG. 5 could occur substantially in parallel. By way of illustration, a first process could select a magneto-resistive field sensing device to associate with a connector and a second process could position the device. While two processes are described, it is to be appreciated that a greater and/or lesser number of processes could be employed and that lightweight processes, regular processes, threads, and other approaches could be employed.

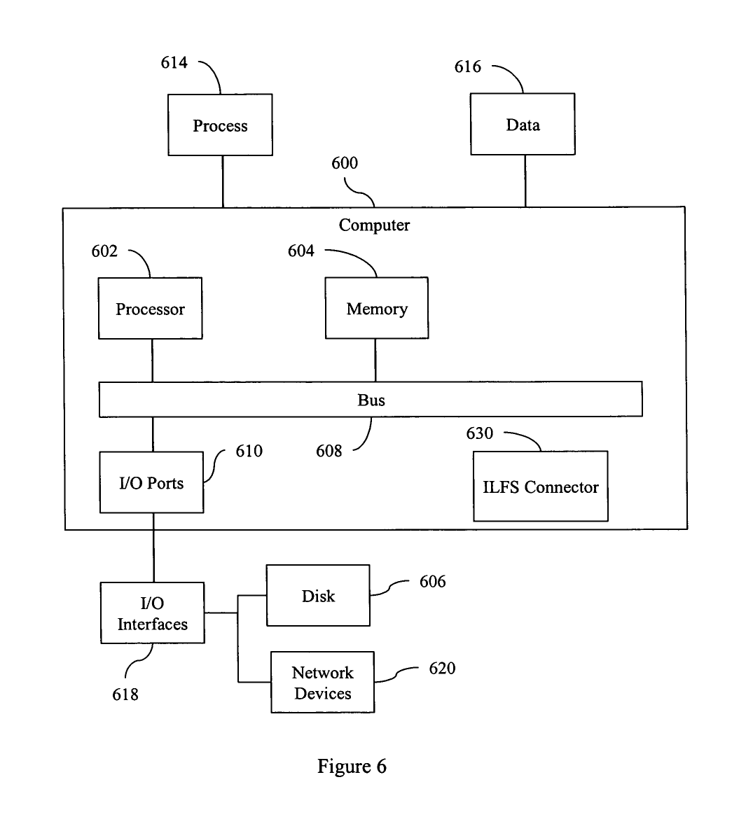

FIG. 6 illustrates a computer 600 that includes a processor 602, a memory 604, and input/output ports 610 operably connected by a bus 608. In one example, the computer 600 may include a connector 630 configured with an in-line field sensor that is configured to measure the current in a conductor carrying an electric signal to a component in the computer 600. For example, power may be supplied to the processor 602 through the bus 608. Thus, a connector that connects lines from the bus 608 to the processor 602 may be configured with an in-line field sensor configured to monitor the current and/or power available to the processor 602 through the bus 608. In one example, the connector 630 configured with the in-line field sensor may be configured to feed a signal back to a power supply that is powering the processor 602 through the bus 608.

The processor 602 can be a variety of various processors including dual microprocessor and other multi-processor architectures. The memory 604 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a compact disc ROM (CD-ROM), a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600. In one example, the memory 604 may be configured to switch to a battery backup if a current and/or power with desired characteristics (e.g., voltage, voltage variance, amperage, amperage variance) is not maintained. Thus connectors through which power and/or current are provided to memory 604 may be configured with an in-line field sensor to facilitate producing a signal that the switch to battery backup should occur.

The bus 608 can be a single internal bus interconnect architecture and/or other bus or mesh architectures. The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and the like. The input/output ports 610 can include but are not limited to, serial ports, parallel ports, and USB ports.

The computer 600 can operate in a network environment and thus may be connected to network devices 620 via the i/o devices 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 620 can connect to WAN technologies including, but not limited to, point to point links, circuit switching networks like integrated services digital networks (ISDN), packet switching networks, and digital subscriber lines (DSL).

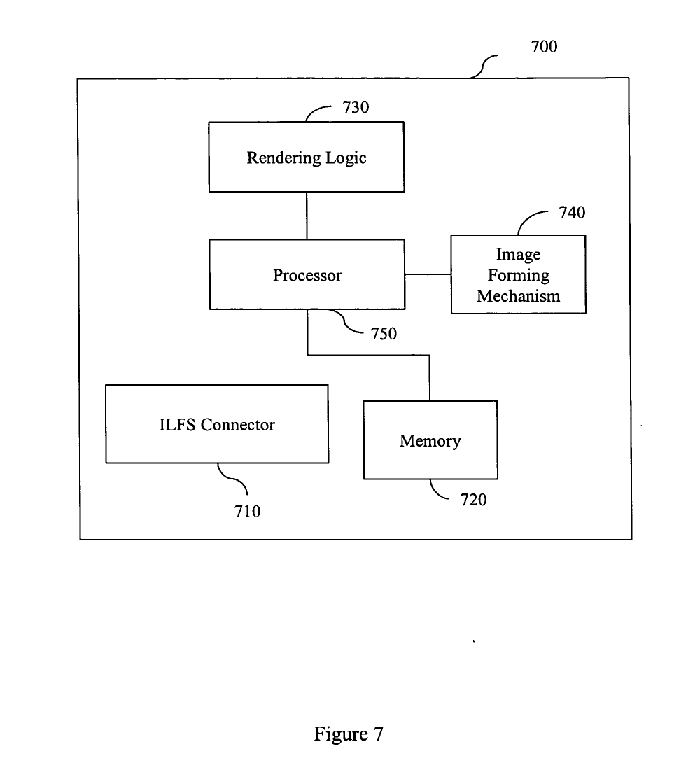

FIG. 7 illustrates an example image forming device 700 in which example connectors 710 configured with in-line field sensors may be located. The image forming device 700 may include a memory 720 configured to store print data, for example, or to be used more generally for image processing. The image forming device 700 may include connectors 710 that are configured with in-line field sensors that facilitate sensing a current and/or power flowing to one or more components in the image forming device 700. For example, the memory 720 may be configured to switch to a battery backup if a current and/or power with desired characteristics (e.g., voltage, voltage variance, current, current variance) is not maintained. Thus a connector 710 configured with an in-line field sensor may be associated with providing power and/or current to memory 720, which can facilitate producing a signal that the switch to battery backup should occur.

The image forming device 700 may receive print data to be rendered. Thus, the image forming device 700 may include a rendering logic 730 configured to generate a printer-ready image from print data. Rendering varies based on the format of the data involved and the type of imaging device. In general, the rendering logic 730 converts high-level data into a graphical image for display or printing (e.g., the print-ready image). For example, one form is ray-tracing that takes a mathematical model of a three-dimensional object or scene and converts it into a bitmap image. Another example is the process of converting HTML into an image for display/printing. It is to be appreciated that the image forming device 700 may receive printer-ready data that does not need to be rendered and thus the rendering logic 730 may not appear in some image forming devices.

The image forming device 700 may also include an image forming mechanism 740 configured to generate an image onto print media from the print-ready image. The image forming mechanism 740 may vary based on the type of the imaging device 700 and may include a laser imaging mechanism, other toner-based imaging mechanisms, an ink jet mechanism, digital imaging mechanism, or other imaging reproduction engine. The image forming mechanism 740 may desire to be kept at a constant “ready temperature”, which may require that power within pre-determined tolerances be available. Thus, a connector through which current flows to the image forming mechanism 740 may be configured with an in-line field sensor that is configured to monitor the current and/or power being supplied to the image forming mechanism 740 and to provide inputs to a circuit controlling the current and/or power supplied to the image forming mechanism 740.

A processor 750 may be included that is implemented with logic to control the operation of the image-forming device 700. In one example, the processor 750 includes logic that is capable of executing Java instructions. Other components of the image forming device 700 are not described herein but may include media handling and storage mechanisms, sensors, controllers, and other components involved in the imaging process.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modem Legal Usage 624 (2d. Ed. 1995).

1. A system, comprising:
a connector configured to convey an electrical signal between a first conductor and a second conductor; and
an in-line field sensor positioned to be within a magnetic field created by the electrical signal conveyed through the connector, the in-line field sensor being configured to detect the magnetic field without affecting the electrical signal.

2. The system of claim 1, where the in-line field sensor comprises a two terminal device.

3. The system of claim 2, where the electrical signal voltage is in a range of about −50 mV to about 50 mV.

4. The system of claim 2, where the electrical signal voltage is in a range of about −15 V to about 15 V.

5. The system of claim 2, where the electrical signal current is in a range of about −50 mA to about 50 mA.

6. The system of claim 2, where the electrical signal current is in the range of about −1 A to about 1 A.

7. The system of claim 2, the in-line field sensor comprising an anisotropic magnetoresistive device.

8. The system of claim 2, the in-line field sensor comprising a giant magnetoresistive device.

9. The system of claim 2, the in-line field sensor comprising a tunneling magnetoresistive device.

10. The system of claim 1, the in-line field sensor being embedded in the connector.

11. The system of claim 1, the in-line field sensor being attached to the connector.

12. The system of claim 1, the in-line field sensor being positioned within the magnetic field but not in physical contact with the connector.

13. The system of claim 1, where the in-line field sensor monitors the magnetic field using one or more of, frequency synthesis and coding synthesis.

14. The system of claim 1, where the electrical signal is provided to one or more of, a microprocessor, a dual in-line memory module, an application specific integrated circuit, an integrated circuit, and a bus.

15. The system of claim 1, the in-line field sensor being positioned to have an easy axis of the in-line field sensor orthogonal to the magnetic field.

16. The system of claim 1, where the in-line field sensor includes a permalloy sensor layer.

17. The system of claim 1, including a feedback logic operably connected to the in-line field sensor, the feedback logic being configured to receive a signal from the in-line field sensor, the signal being related to an attribute of the electrical signal flowing through the connector.

18. The system of claim 17, the attribute being one of, an electrical signal current, an electrical signal voltage, and an electrical circuit power.

19. The system of claim 17, the feedback logic being further configured to control one or more devices involved in providing the electrical signal to the first conductor.

20. The system of claim 2, the system being located in a computer.

21. The system of claim 2, the system being located in an image-forming device.

22. The system of claim 2, the system being located in a cellular telephone.

23. The system of claim 1, the in-line field sensor being configured to generate a signal that indicates one or more of, a current associated with the electrical signal, a voltage associated with the electrical signal, and a power associated with the electrical signal.

24. A method, comprising:
receiving a first signal from a magneto-resistive sensing device positioned at least partially within a magnetic field produced by an electrical signal flowing through a connector, the first signal being related to a variable resistance in the magneto-resistive sensing device, the variable resistance being determined, at least in part, by the magnetic field, the first signal being received without altering the electrical signal;
characterizing one or more attributes of the electrical signal based, at least in part, on the first signal; and
selectively producing a second signal based, at least in part, on one or more of the attributes.

25. The method of claim 24, further including indicating an instant resistance in the magneto-resistive device based on the first signal.

26. The method of claim 24, further including indicating a resistance change in the magneto-resistive device based on the first signal.

27. The method of claim 24, where characterizing the one or more attributes of the electrical signal includes one or more of, producing a current measurement, producing a current change measurement, producing a power measurement, producing a power change measurement, producing a voltage measurement, and producing a voltage change measurement.

28. The method of claim 27, further including selectively controlling an electronic device via the second signal, the second signal being based, at least in part, on one or more of, the current measurement, the current change measurement, the power measurement, the power change measurement, the voltage measurement, and the voltage change measurement.

29. A computer-readable medium storing processor executable instructions operable to perform a method, the method comprising:
receiving a first signal from a magneto-resistive sensing device positioned at least partially within a magnetic field produced by an electrical signal flowing through a connector, the first signal being related to a variable resistance in the magneto-resistive sensing device, the resistance being determined, at least in part, by the magnetic field, the first signal being received without altering the electrical signal;
characterizing one or more attributes of the electrical signal based, at least in part, on the first signal; and
selectively producing a second signal based, at least in part, on one or more of the attributes.

30. A method, comprising:
selecting a magneto-resistive sensing device with a variable resistance that can be detectably altered by an impinging magnetic field; and
positioning the magneto-resistive sensing device relative to a conductor so that the magneto-resistive sensing device will be impinged by a magnetic field produced by an electrical signal flowing through the conductor.

31. The method of claim 30, where the conductor is associated with an electrical connector.

32. The method of claim 31, further including configuring the magneto-resistive sensing device to generate a signal that communicates information concerning the variable resistance.

33. The method of claim 32, further including operably connecting a feedback logic to the magneto-resistive sensing device.

34. The method of claim 33, further including configuring the feedback logic to condition the electrical signal based, at least in part, on the signal.

35. A system, comprising:
means for obtaining one or more attributes of an electrical signal flowing through a conductor in a connector without affecting the electrical signal; and
means for selectively controlling the electrical signal based, at least in part, on the one or more attributes.
